(19) United States
(12) Patent Application Publication
(10) Pub. No.: US 2015/0026673 A1
(43) Pub. Date: Jan. 22, 2015

(54) ENFORCING EXTERNAL INSTALL REQUIREMENTS DURING SOFTWARE DEPLOYMENT

(71) Applicant: International Business Machines Corporation, Armonk, NY (US)

(72) Inventor: Rohit Shetty, Bangalore (IN)

(73) Assignee: International Business Machines Corporation, Armonk, NY (US)

(21) Appl. No.: 13/947,504

(22) Filed: Jul. 22, 2013

(51) Int. Cl. G06F 9/445

(52) U.S. Cl. CPC G06F 8/61
USPC 717/174

(57) ABSTRACT

A method, system and article of manufacture are disclosed for policy-based enforcement of business requirements for a software install. The method comprises the steps of determining a policy infrastructure analogous to one or more business requirements; and embedding the policy infrastructure in a software installation process for installing a given software application. The software installation process is used to install the given software application into a computer system while ensuring that all installation prerequisites of the software application are met during the install. In a preferred embodiment of the invention, the determining step includes the step of preparing one or more policies for the business requirements, each of the policies including a condition part that evaluates either to true or false, and an action part that specifies one or more actions to be taken if the condition part evaluates to true.

### FIELD OF INVENTION

This disclosure is related to policy based enforcement of business requirements for software deployment, and more specifically to enforcing external installation requirements during software deployment.

### BACKGROUND

When a new software program is acquired, it usually must be installed on the target data processing system before it can be used. Typically, software programs include as a component thereof an installer, which is software that substantially automates the installation process. In addition, computer operating systems (software which coordinates resource use by, and interaction between, other software) may include an installer for use in installing drivers or other software.

In addition, many commercial software programs are provided with a process by which they may be updated, and can be included as a component of the software program itself, or may be provided externally. The provision of an updating process is desirable because end users, for example, frequently modify software programs by applying bug fixes or enhancements, for example, new versions of the software.

There are a number of processes available for installing and/or updating software programs. Some processes are entirely automated and substantially invisible to the user, while others are interactive. Some are complex while others are simpler. Software programs used to install new software, to install updates to software, and to uninstall (remove) software are referred to as “installer” applications, which is intended to encompass both “standalone” software programs that can be used to install a variety of software applications, for example, installers that may be provided with an operating system, as well as software programs that are adapted to install only a single software application, which may be integrated with the installation file package for that software application. Installer applications, when run, implement a software installation process.

### SUMMARY

Embodiments of the invention provide a method and system for policy based enforcement of a customer's external install requirements for software deployment, and to validate before hand whether a particular software installation would comply with a customer's business policy. An embodiment of the invention is to ensure that a software installation does not break a customer's business policy, and to embed into a software installer a Policy Infrastructure that will interpret and enforce a customer's business policies in the installation process while ensuring that the prerequisites for the software have been met.

Embodiments of the invention provide a method, system and article of manufacture for policy-based enforcement of external requirements for a software install. The method comprises determining a policy infrastructure analogous to one or more requirements; and embedding the policy infrastructure in a software installation process for installing a given software application, the software application having one or more installation prerequisites. The software installation process is used to install the given software application into a computer system while ensuring that the one or more installation prerequisites are met during the install.

In a further embodiment, the determining step includes the preparing one or more Policies for the business requirements, each of the Policies including a Condition part that evaluates either to true or false, and an action part that specifies one or more actions to be taken if the Condition part evaluates to true. Also, in this embodiment, a plurality of Deployment Descriptors are provided for identifying the software installation prerequisites; and the one or more actions specified in the action part of the Policies include a Deployment Descriptor Independent action, and a Deployment Descriptor Dependent action. The Deployment Descriptor Independent action performs an action specified by a user of the computer system. If the Deployment Descriptor Dependent action violates any mandatory clause of the Deployment Descriptor, then exception approval is sought to ignore the action and to continue installation of the software application. However, if the Deployment Descriptor Dependent action does not violate any mandatory clause of the Deployment Descriptor, then the action is performed.

In a further embodiment of the invention, as described below in detail, is embedded a Policy Infrastructure into a software installer. The Policy Infrastructure will interpret and enforce the Customer's Business Policies in the installation process while ensuring that the prerequisites for the software have been met.

Without this infrastructure, the customer will not be able to enforce or verify that the software solution complies with all his Business Policies. With no control over the solution the customer would have to manually carry out an impact analysis, which is a complicated and time-consuming task. Most customers currently overlook these Business Policy violations, as there is no way of enforcing them automatically. This results in audit vulnerability. The solution in the present disclosure, hence, provides an important assurance to customers who are currently facing such problems.

This technique also makes the software install highly flexible, by allowing customers to modify deployment descriptors to suit their business needs as long as it does not conflict with the software prerequisites. Embodiments of the invention will give the vendor a competitive edge over other vendors who are not able to provide flexible solutions that accommodate the customer's Business Policies.

Further benefits and advantages of this invention will become apparent from a consideration of the following detailed description, given with reference to the accompanying drawings, which specify and show preferred embodiments of the invention.

### BRIEF DESCRIPTION OF THE SEVERAL VIEWS OF THE DRAWINGS

FIG. 1 shows an existing software installation architecture.

FIG. 2 illustrates a software installation architecture embodying this invention, when the Installer is coupled with a Policy Infrastructure.

FIG. 3 depicts a high level architecture of the Policy Engine shown in FIG. 2.

FIG. 4 shows the high level design of the policy infrastructure.

FIG. 5 illustrates an method that may be used to implement embodiments of the invention.

FIG. 6 is an exemplary diagram of a distributed data processing system in which embodiments of the invention may be implemented.

FIG. 7 shows an example diagram of a server-computing device that may be used as a server in the system of FIG. 6.

### DETAILED DESCRIPTION

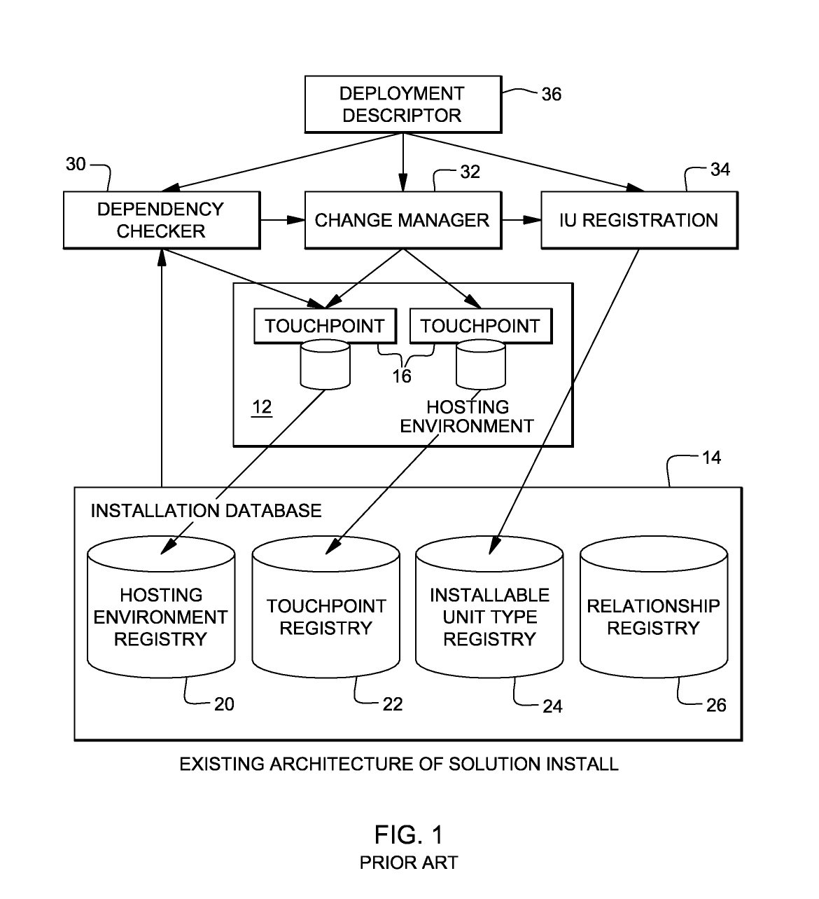

FIG. 1 shows the existing architecture of a Solution Install. This architecture, generally, includes hosting environment 12 and installation database 14. In turn, the hosting environment 12 includes touchpoints 16; and the installation database 14 includes a hosting environment registry 20, a touchpoint registry 22, an installable unit type registry 24, and a relationship registry 26. The architecture of FIG. 1 also includes a dependency checker 30, change manager 32, IU registration 34 and deployment descriptor 36. The Solution Install architecture is discussed in more detail in “Simplify Deployment Tasks with Solution Install Technology”, Charlie Halloran, Jr., 10 May 2005, http://www.ibm.com/developerworks/autonomic/library/ac-sivalue/. Most installers follow the same architecture as the Solution Install, i.e., they have a deployment descriptor 36 (change plan) and similar interactions as the Solution Install.

In accordance with embodiment of the invention, the process of software installation is customized and managed using a Policy Infrastructure. As discussed in detail below, embodiments of the invention enable the customer to write policies or use existing policies that will change the course of the installation to enforce Business Requirements (BR) based on the information available in the deployment descriptor 36. The usage of instrumentation to define business policies that can be used to automate software installation through the Policy Infrastructure embedded into the software installer.

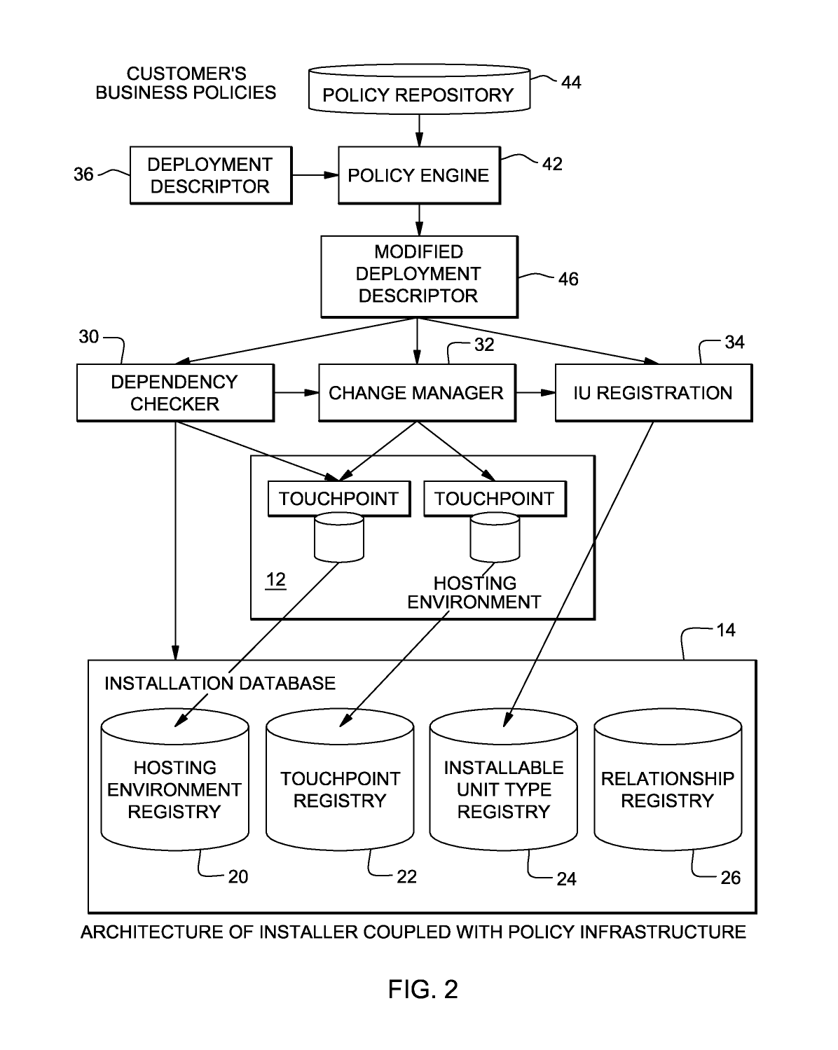

FIG. 2 illustrates an architecture embodying the invention. This architecture includes the hosting environment 12, the installation database 14, the dependency checker 30, the change manager 32, and the IU registration 34 shown in FIG. 1. In addition, the architecture of FIG. 2 includes a policy engine 42, a policy repository 44 and a modified deployment descriptor 46. Also, with the architecture of FIG. 2, the deployment descriptor 36 provides input to the policy engine 42, rather than directly to the dependency checker 30, change manager 32 and IU registration 34.

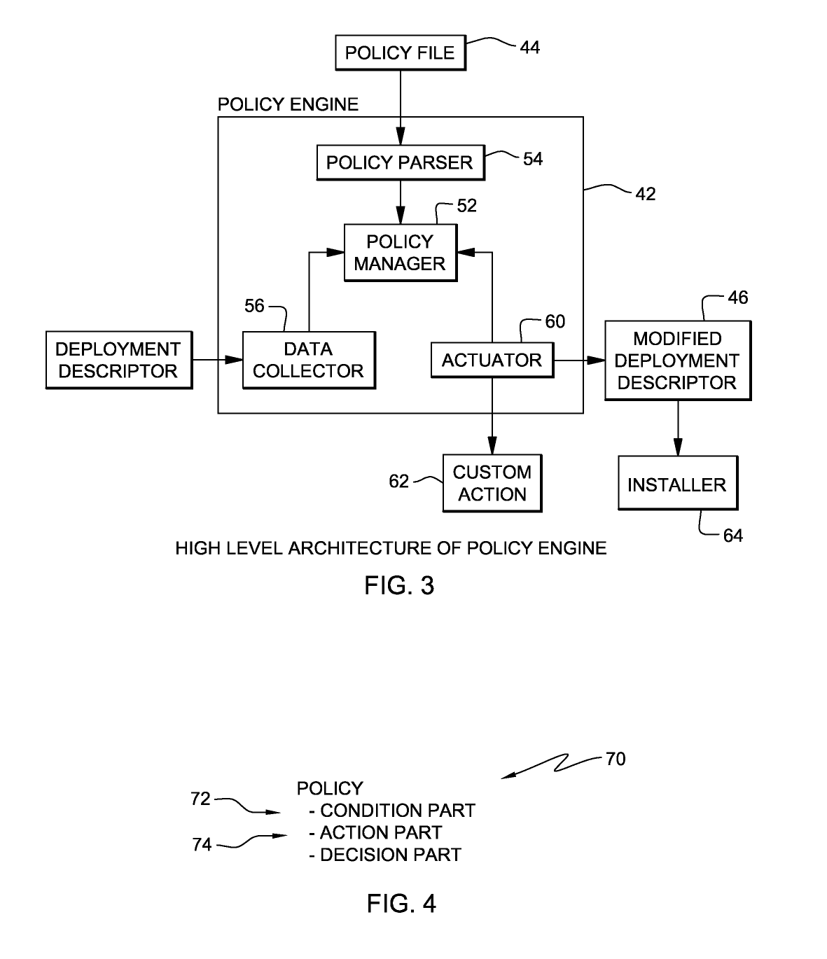

FIG. 3 shows the architecture of the policy engine 42. In this architecture, the policy engine 42 comprises a policy manager 52, a policy parser 54, a data collector 56, and an actuator 60. FIG. 3 also shows the policy file 44, and a custom action 62. FIG. 4 shows the high level design of the policy infrastructure 70.

The solution provided by embodiments of the invention aims to use a policy repository 44 to store all the policies written by the user. The policies stored in the policy repository 44 are written to suit the Business Requirements (BR). These policies are preferably based on the deployment descriptor 36 schema used. Embodiments of this invention aims to embed a policy engine 42 that will interpret the customer's Business Policies stored in the policy repository 44 for the installer 64. This enables the policy infrastructure 70 to enforce the business requirements over a range of solutions without being tied to a particular solution.

The condition part 72 of the policy infrastructure 70 is comprised of expressions that work with the prerequisite and other requirements described in the deployment descriptor 36. The condition can either evaluate to true or false. If it evaluates to true, then the action part 74 of the policy infrastructure 70 is executed, else the execution of that policy infrastructure 70 is skipped and normal installation is resumed.

The action part 74 of the policy infrastructure 70 is comprised of custom actions or management operations and information about installable units to be used. The actuator 60 is responsible for creating a modified deployment descriptor 46 that contains the updated information. This modified deployment descriptor 46 is passed on to the change manager 32. The installer 64 then continues normal installation. If a conflict between Dependencies and Business Requirement should arise, the policy engine 42 will ask for guidance from the user. This is as good as throwing an error, where the user would have to resolve the conflict.

The architecture aims primarily at creating the best install plan that satisfies the Business Requirements for the customer in a given environment. The install plan is comprised of a good mix of Dependencies and the Business Guidelines as specified by the Policies.

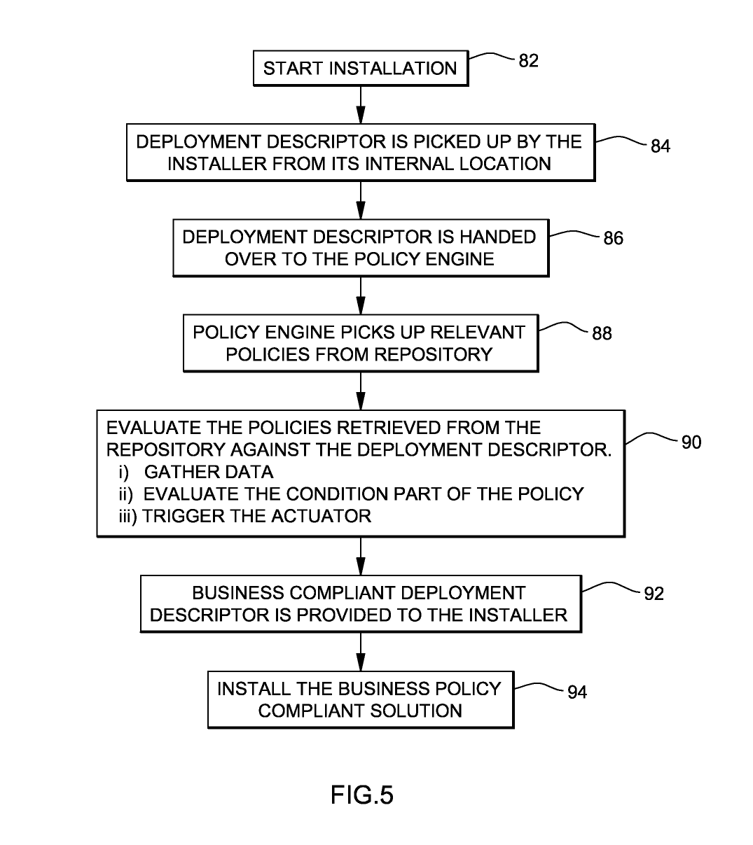

FIG. 5 illustrates a method 80 that may be used to practice embodiments of the invention. At step 82, the installation is started; and at step 84, the installer 64 from its internal location picks up the deployment descriptor 36. At step 86, the deployment descriptor 36 is handed over to policy engine 42; and at step 88, the policy engine 42 picks up relevant Policies from the repository. Step 90 is to evaluate the policies retrieved from the repository against the deployment descriptor 36. This is done, more specifically, by gathering data from the deployment descriptor 36, and evaluating the condition part 72 of the policy Infrastructure 70 against the data gathered from the deployment descriptor 36. Based on the evaluation of the condition, the actuator 60 is triggered to take the associated action.

The actuator 60 can execute two kinds of actions: Deployment Descriptor Independent actions and Deployment Descriptor Dependent actions. In the case of Deployment descriptor independent actions, the actuator 60 performs the action specified by user in the decision part 74 of the policy infrastructure 70. In the case of Deployment Descriptor Dependent actions, the actuator 60 checks to see if the action violates a mandatory clause of the deployment descriptor 36.

In case of a violation of a mandatory clause of the deployment descriptor 36 the customer is notified and exception approvals are sought to ignore violation and continue with the install. If the action does not violate any mandatory clause of the deployment descriptor 36, then the method goes on and performs the action, i.e., changes the deployment descriptor 36 as required by the policy infrastructure 70 (for example, if the policy says min 50 MB should exist on the system at all times, the deployment descriptor 36 would be used to check for [required+50 MB] dependency). This step orchestrates the impact analysis for the actions and the steps mentioned above can be updated/modified based on the requirements. Steps 88 and 90 are repeated for all relevant policies. After this, at step 92, the business compliant deployment descriptor 36 is provided to the installer; and, at step 94, the Installer will go ahead and install the Business Policy Compliant Solution.

For example, due to a change in the licensing terms of software such as Java (Java is a Trademark of Oracle Corporation in the US and other countries), a Company decides that it does not want to install Java on any of its systems. Under normal conditions this would require a rework on the solution or an entirely new solution. Therefore, the Business Policy of a company say Policy 2, insists that all Java dependant installations should use only XYZ Java (“XYZ Java” is an exemplary distribution of Java).

A solution, say Software Y, has a prerequisite of Sun Java. This can be represented as follows.

### Prerequisite 1 (P1): Java

The Deployment descriptor 36 would have a dependency check as follows:

### Prerequisite 1 (P1)

If (Java==not installed)
{Include installable unit corresponding to Sun Java}

The prerequisite check can be changed to look as follows:

### Prerequisite 1 (P1)

If ((Java==not installed) OR (Java==Sun(Oracle)))
{Include installable unit corresponding to XYZ Java}

The installer (with embedded policy infrastructure 70) would install the solution as follows:
1) The installation is triggered.
2) Deployment descriptor 36 is picked up by the installer.
3) Deployment descriptor 36 is handed over to policy engine 42.
4) Policy engine 42 picks up relevant Policies (filtered by scope if required) from the Customers Business Policy Repository.
5) Policy 2 is retrieved from the repository and evaluated against the deployment descriptor 36.

The data from the deployment descriptor 36 (Prerequisites P1) is given as input to the evaluation engine. The policy infrastructure 70 can be interpreted to mean that all software that has a Java dependency should use XYZ Java instead of Java (Sun/Oracle). The condition part 72 of the policy infrastructure 70 in this case would check to see if the installation has a Sun Java Dependency. Since the current deployment descriptor 36 has a Sun Java Dependency, the actuator 60 would be triggered to take the associated action.

The actuator 60 can execute two kinds of actions, either deployment descriptor 36 Independent actions, or Deployment Descriptor Dependent actions. Deployment Descriptor Independent actions could include triggering XYZ Java installation and uninstalling Java. This is one way of enforcing the policy infrastructure 70. Deployment Descriptor Dependent actions would include modification of the prerequisite to comply with the policy infrastructure 70. A check may be made first to see if the action violates a mandatory clause of the deployment descriptor 36. The software has a Java prerequisite, but Java (Sun/Oracle) is not mandatory, hence the change to XYZ Java throws no exception approval message. Hence, the deployment descriptor 36 can be changed as required by the policy infrastructure 70, i.e., prerequisite P1 is modified to check for NO Java or Java (Sun/Oracle) condition and, accordingly, include XYZ Java installable unit. The user can be notified about the actions to be taken. This would help him carry out an impact analysis of the installation. The same evaluation process is carried out for all the Policies that have been retrieved from the repository.

After the evaluation process is completed, the business compliant deployment descriptor 36 is provided to the installer. Installer will go ahead and install the Business Policy Compliant Solution which would ensure that XYZ Java is used by the solution instead of Java.

The customer might want to create a table that contains information to guide the install, uninstall and upgrade of software. The table contains information about the following:
a) Supported configurations of Software (patch level, service pack level, sub components supported etc).
b) Critical Software that must be running at all times (Software that should not be uninstalled).
c) Number of licenses available for all the different types of Software (Installation should be preceded by a check to see if the required licenses are available).

For example, a solution may require a prerequisite Software Y. The customer may want to check the table to see if a license is available for Software Y. This information (Number of available licenses) is listed in the table. The policy infrastructure 70 corresponding to this requirement (Policy 3) would require all software to be checked against the table. This can be represented as follows:

### Prerequisite 1 (P1): Software Y

The deployment descriptor 36 would have a dependency check as follows:

### Prerequisite 1 (P1)

If ( Software Y == not installed)
{Include installable unit corresponding to Software Y}

The prerequisite check needs to look the same, but the table needs to be checked for data related to Software Y. This would qualify as a custom action 62. This custom action 62 would check the table for information about the number of licenses available for Software Y. If sufficient numbers of licenses are available, then the deployment descriptor 36 is updated to allow installation of Software Y.

### Custom Action (CA)

Check the table for information about the number of licenses available for software Y

### Prerequisite 1 (P1)

If (( Software Y == not installed))
{Include installable unit corresponding to Software Y}

The installer (with embedded policy infrastructure 70) would install the solution as follows:
1) The installation is triggered.
2) Deployment descriptor 36 is picked up by the installer.
3) Deployment descriptor 36 is handed over to policy engine 42.
4) Policy engine 42 picks up relevant Policies (filtered by scope if required) from the Customers Business Policy Repository.
5) Policy 3 is retrieved from the repository and evaluated against the deployment descriptor 36.

The data from the deployment descriptor 36 (Prerequisites P1) is given as input to the evaluation engine. The policy infrastructure 70 can be interpreted to mean that all software that needs to be installed needs to pass the license check (Custom action). The condition part 72 of the policy infrastructure 70 in this case would comprise of a custom action 62 that checks to see if the required numbers of licenses are available to install the prerequisite. Since the current deployment descriptor 36 has a Software Y dependency, the actuator 60 would be triggered to take the associated action (modify deployment descriptor 36 to allow installation of the prerequisite).

The actuator 60 can execute two kinds of actions, either Deployment Descriptor Independent actions, or Deployment Descriptor Dependent actions. Deployment Descriptor Independent actions could include reducing the number of licenses available for Software Y in the table by one. Deployment Descriptor Dependent actions would include modification of the prerequisite to comply with the policy infrastructure 70. In this case, the deployment descriptor 36 does not need to be changed, as the prerequisite remains the same. If the policy infrastructure 70 is not satisfied, the deployment descriptor 36 would have to be changed to remove the installable unit corresponding to Software Y. If Software Y is mandatory and the license condition is not satisfied, then the customer needs to be notified about the dearth of licenses. If Software Y is not mandatory, the deployment descriptor 36 can be changed, as required by the policy infrastructure 70, i.e., prerequisite P1 is added or removed from the deployment descriptor 36 based on the evaluation of Policy 3. The user can be notified about the actions to be taken. This would help him carry out an impact analysis of the installation. The same evaluation process is carried out for all the Policies that have been retrieved from the repository.

After the evaluation process is completed, the business compliant deployment descriptor 36 is provided to the installer. Installer will go ahead and install the Business Policy Compliant Solution. This policy infrastructure 70 would ensure that all Software installations are preceded by a custom check that verifies the existence of required licenses.

For example, Business Policy of a company, Policy 1 insists that 50 MB of free disk space must be maintained at all times on any given system. Without the policy infrastructure 70 as disclosed previously in accordance with embodiments of the invention, there would be no way for the company to automatically enforce their policy. They would have to either manually ensure that all systems comply with this policy or buy another solution that takes care of their requirements. This scenario can be handled in an easier manner by using the above-described algorithm.

For example, a solution Software X has a prerequisite of 150 MB of disk space and min 100 MHz processor. This can be represented as follows:
Prerequisite 1 (P1): 150 MB of disk space
Prerequisite 2 (P2): Min 100 MHz processor

The deployment descriptor 36 would have a dependency check as follows:

If ((P1) && (P2))
{Return TRUE to Change Manager indicating that all dependencies
have been satisfied}
Else
{Report an Error}

The prerequisite check looks like this:

If ((Available disk space >= (P1+50MB)) && (P2))
{Return TRUE to Change Manager indicating that all dependencies
have been satisfied}
Else
{Report an Error}

The installer (with embedded policy infrastructure 70) would install the solution as follows.
1) The installation is triggered.
2) Deployment descriptor 36 is picked up by the installer.
3) Deployment descriptor 36 is handed over to policy engine 42.
4) Policy engine 42 picks up relevant Policies (filtered by scope if required) from the Customers Business Policy Repository.
5) Policy 1 is retrieved from the repository and evaluated against the deployment descriptor 36.

The data from the deployment descriptor 36 (Prerequisites P1 and P2) is given as input to the evaluation engine. The Policy can be interpreted to mean that all software must ensure that they check for 50 MB of disk space beyond their individual requirements. The condition part 72 of the Policy in this case would check to see if the installation has a disk space prerequisite. Since the current deployment descriptor 36 does have a memory prerequisite, the actuator 60 would be triggered to take the associated action.

The program could get 50 MB of space allocated to itself and release it after the installation, which is one way of enforcing the Policy. Deployment Descriptor Dependent actions would include modification of the prerequisite to comply with the policy. A check is first made to see if the action violates a mandatory clause of the deployment descriptor 36. Since the memory prerequisite is not being decreased to below the mandatory level of 150 MB, no exception approval messages are thrown. Hence, the deployment descriptor 36 can be changed as required by the policy, i.e., prerequisite P1 is modified to check for 150 MB+50 MB of disk space. The user can be notified about the actions to be taken. This would help the user carry out an impact analysis of the installation. The same evaluation process is carried out for all the Policies that have been retrieved from the repository.

After the evaluation process is completed, the business compliant deployment descriptor 36 is provided to the installer. The installer can go ahead and install the Business Policy Compliant Solution, which would ensure 50 MB of free disk space on the system.

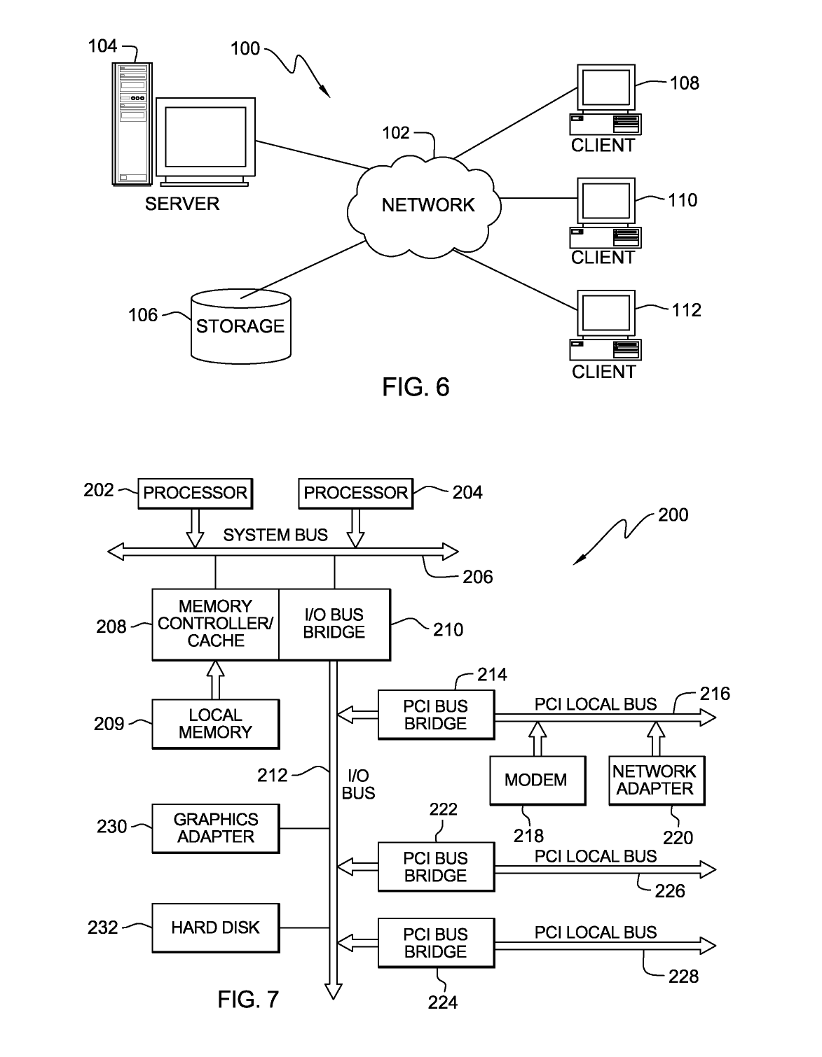

FIG. 6 depicts a pictorial representation of a collection of data processing systems in which embodiments of the invention may be implemented. System 100 is a network of computers and includes network 102, which is the medium used to provide communications links between various devices and computers connected together within system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. System 100 may include additional servers, clients, and other devices not shown. In the depicted example, system 100 includes the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, system 100 also may be implemented with a number of different types of networks, such as for example, an intranet, a local area network (LAN), or a wide area network (WAN). FIG. 6 is intended as an example, and not as an architectural limitation for the present invention.

FIG. 7 depicts a block diagram of a data processing system that may be implemented as a server, such as server 104 in FIG. 6. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 6 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 7 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 7 may be, for example, a system running the LINUX operating system (Linux is a trademark of Linus Torvalds in the United States, other countries, or both).

As will be readily apparent to those skilled in the art, various embodiments of the invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

Embodiments or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that embodiments of the invention herein disclosed is well calculated to fulfill the objects stated above, it will be appreciated that numerous modifications and embodiments may be devised by those skilled in the art, and it is intended that the appended claims cover all such modifications and fall within the true spirit and scope of the various embodiments of the invention.

What is claimed is:

1. A method for application install, the method comprising the steps of:
determining a policy infrastructure analogous to one or more requirements;
embedding the policy infrastructure in a software installation process for installing an application, wherein the application includes one or more installation prerequisites; and
using the installation process to install the application while ensuring that the one or more installation prerequisites and the policy infrastructure are met during the install.

2. The method as claimed in claim 1 wherein the one or more requirements include a business requirement or a business policy.

3. The method as claimed in claim 1, wherein the application is a software.

4. The method as claimed in claim 1, wherein the determining step includes the step of preparing one or more policies for the one or more requirements, each of the policies including:
a condition part that evaluates either to true or false; and
an action part that specifies one or more actions to be taken if the condition part evaluates to true.

5. The method as claimed in claim 4, wherein a deployment descriptor is provided for identifying the installation prerequisites.

6. The method as claimed in claim 4, wherein the one or more actions include a deployment descriptor independent action, and a deployment descriptor dependent action.

7. The method as claimed in claim 6, wherein the deployment descriptor independent action performs an action specified by a user.

8. The method according to claim 7, wherein the action specified by the user is specified in a decision part of the policy.

9. The method as claimed in claim 8, wherein the using step includes checking to determine if the deployment descriptor dependent action violates a mandatory clause of the deployment descriptor.

10. The method as claimed in claim 9, wherein the using step includes the further step of, if the deployment descriptor dependent action violates the mandatory clause, then seeking exception approval to ignore the action and to continue installation of the application.

11. The method as claimed in claim 9, wherein the using step includes the further step of, if the deployment descriptor dependent action does not violate any mandatory clause of the deployment descriptor, then performing the action.

12. The method according to claim 5, wherein the using step includes the step of, if the software install conflicts with the policy infrastructure analogous to one or more business requirements, then modifying the deployment descriptor.

13. A system for installing applications, the system comprising:
a policy engine for determining a policy infrastructure analogous to one or more business requirements, and for embedding the policy infrastructure in a software installation process for installing a software application, wherein the software application has one or more installation prerequisites; and
an installer for using the software installation process to install the software application while ensuring that the one or more installation prerequisites and the policy infrastructure are met during the install.

14. The system as claimed in claim 13, further comprising a policy file for holding a plurality of policies for the business requirements, each of the Policies including:
a condition part that evaluates either to true or false; and
an action part that specifies one or more actions to be taken if the condition part evaluates to true.

15. The system as claimed in claim 13, further comprising a deployment descriptor module for holding a plurality of deployment descriptors for identifying the installation prerequisites, and wherein the policy engine obtains deployment descriptors from the deployment descriptor module and obtains policies from a policy file.

16. The system as claimed in claim 15, wherein:
the one or more actions include a deployment descriptor independent action, and a deployment descriptor dependent action;
the deployment descriptor independent action performs an action specified by a user; and
the policy engine checks to determine if the deployment descriptor dependent action violates a mandatory clause of the deployment descriptor.

17. The system as claimed in claim 16, wherein:
if the deployment descriptor dependent action violates the mandatory clause, then the policy engine seeks exception approval to ignore the action and to continue installation of the software application; and
if the deployment descriptor dependent action does not violate any mandatory clause of the deployment descriptor, then the policy engine performs the action.

18. An article of manufacture comprising:
at least one computer usable medium having computer readable program code logic to execute a machine instruction in a processing unit for enforcing policy based business requirements for a software install, the computer readable program code logic, when executing, performing the following steps:
determining a policy infrastructure analogous to one or more business requirements;
embedding the policy infrastructure in a software installation process for installing a software application, the software application having one or more installation prerequisites; and
using the software installation process to install the software application into a computer system while ensuring that the one or more installation prerequisites and policy infrastructure are met during the install.

19. The article of manufacture as claimed in claim 18, wherein:
the determining step includes the step of preparing one or more policies for the business requirements, each of the policies including a condition part that evaluates either to true or false;
and an action part that specifies one or more actions to be taken if the condition part evaluates to true:
a plurality of deployment descriptors are provided for identifying the installation prerequisites; and
the one or more actions include a deployment descriptor independent action, and a deployment descriptor dependent action.

20. The article of manufacture as claimed in claim 18, wherein:
the deployment descriptor independent action performs an action specified by a user of the computer system;
the using step includes the step of checking to determine if the deployment descriptor dependent action violates a mandatory clause of a deployment descriptor; and
wherein the using step includes the steps of:
if the deployment descriptor dependent action violates the mandatory clause, then seeking exception approval to ignore the action and to continue installation of the software application;
if the deployment descriptor dependent action does not violate any mandatory clause of the deployment descriptor, then performing the action; and
wherein the using step includes the step of, if the software install conflicts with the policy infrastructure analogous to one or more business requirements, then modifying the deployment descriptor.
